(19) United States
(12) Patent Application Publication
(10) Pub. No.: US 2013/0213537 A1
(43) Pub. Date: Aug. 22, 2013

(54) Sneaker Purse and Methods for Making a Sneaker Purse

(71) Applicant: Jill Auger, Tilton, NH (US)

(72) Inventor: Jill Auger, Tilton, NH (US)

(21) Appl. No.: 13/399,418

(22) Filed: Feb. 17, 2012

(51) Int. Cl. A45C 3/06; A45C 13/30; B23P 19/04

(52) U.S. Cl. 150/110; 150/100; 150/112; 29/428; 150/129

(57) ABSTRACT

A sneaker purse and methods for forming a sneaker purse are presented. The sneaker purse is formed from portions of a first sneaker and a second sneaker. The sole of the first sneaker acts as the bottom of the shoe purse, while the sides and heels of the first and second sneaker upper portions form the sides of the purse. The joined upper portions form an upper section of the purse. An interior cavity of the purse is lined defining a primary interior portion. An opening portion is attached to the purse upper portion. The opening portion may be alternatively opened and fastened closed.

### FIELD OF THE INVENTION

The present invention relates to fashion accessories and more particularly, is related to a handbag.

### BACKGROUND OF THE INVENTION

Purses and handbags serve both utilitarian and fashion purposes. In terms of utility, a purse is a convenient way to transport everyday items, for example, keys, a wallet, a cell phone, pens, and other personal items. In terms of fashion, purses may be styled to match a clothing outfit or shoes, or be themed to identify interests or personality traits of the carrier.

Women have traditionally carried or purses, as a convenient and stylish way of transporting wallets and personal items. Increasingly, men have begun carrying “man purses” as well. Unfortunately, even though a purse may be very utilitarian, the feminine association with purses may be discouraging to some men, and to some women who are uncomfortable with the stigma that may be associated with carrying a purse.

Purses are available in many styles and made from many materials. For example, leather is a common material for making purses. Some individuals may not wish to carry a purse made of leather, and others may consider fancy purses made from specialized materials to be a statement of excess. Some such individuals may be more comfortable carrying a purse having more gender neutral characteristics. Similarly, some individuals may prefer a purse that may be made of ecologically friendly re-used materials, or materials that may otherwise be discarded or wasted. In addition, some athletes may be uncomfortable carrying a purse, due to stereotypes that do not associate athletes with purses.

Therefore, there is a need in the industry for a purse that addresses these shortcomings.

### SUMMARY OF THE INVENTION

Embodiments of the present invention provide a sneaker purse and methods for making a sneaker purse. Briefly described, a first aspect of the present invention is directed to a handbag with a bottom, an upper section and a primary interior compartment. The handbag includes a first sneaker with a base attached to a first upper portion, the first upper portion further including a first heel disposed between a first instep side and a first outer side, the base further including a sole, and a second sneaker with a second upper portion, the second upper portion further including a second heel, a second instep side and a second outer side. The handbag bottom includes the base, and the upper section includes the first upper portion, and the second upper portion.

A second aspect of the present invention is directed to a method for forming a handbag from a first sneaker having a first base attached to a first upper portion, the first upper portion further having a first heel disposed between a first instep side and a first outer side, and a first toe disposed opposite the first heel and between the first instep side and the first outer side, the toe attached to a first tongue, the base further having a sole, and a side panel having an instep panel, an outer panel, a toe panel and a heel panel, and a second sneaker having a second upper portion, the second upper portion further having a second heel disposed between a second instep side and a second outer side, the method including the step of attaching the first sneaker to the second sneaker.

Briefly described, in architecture, a third aspect of the present invention is directed to a method for forming a handbag, including the steps of forming an upper portion from a first sneaker instep, a second sneaker instep, a first sneaker outer side, and a second sneaker outer side, attaching the first sneaker instep to the second instep, attaching the first sneaker outer side to the second sneaker outer side, forming an interior compartment within the upper portion and attaching the upper portion to a base, wherein the base includes a sneaker bottom portion.

Other systems, methods and features of the present invention will be or become apparent to one having ordinary skill in the art upon examining the following drawings and detailed description. It is intended that all such additional systems, methods, and features be included in this description, be within the scope of the present invention and protected by the accompanying claims.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principals of the invention.

FIG. 1 is a schematic diagram of an exemplary embodiment of a sneaker purse shown from a side view.

FIG. 2 is a schematic diagram of an exemplary embodiment of a sneaker purse shown from a top view.

FIG. 3 is a schematic diagram of an exemplary embodiment of a sneaker purse shown from a front view.

FIG. 4 is a schematic diagram of an exemplary embodiment of a sneaker purse shown from a rear view.

FIG. 5 is a cutaway schematic diagram of an exemplary embodiment of a sneaker purse shown from a side view.

FIG. 6 is a flowchart of an exemplary method for forming a sneaker purse.

FIG. 7 is a flowchart expanding a detail of an exemplary method for forming a speaker purse.

### DETAILED DESCRIPTION

Reference will now be made in detail to embodiments of the present invention, examples of which are illustrated in the accompanying drawings. Wherever possible, the same reference numbers are used in the drawings and the description to refer to the same or like parts.

Exemplary embodiments of a sneaker purse are presented. The sneaker purse is largely formed from portions of a first sneaker and a second sneaker. The sole of the first sneaker acts as the bottom of the shoe purse, while the sides and heels of the first and second sneaker upper portions form the sides of the purse. The tongues of both sneakers are removed. The base of the second sneaker is removed, and the second sneaker upper portion is attached to the first sneaker with the first sneaker and the second sneaker oriented in opposite directions, so the heel of the second sneaker attaches to the toe-side base of the first sneaker, and portions toward the heel side of the first sneaker are attached to portions toward the toe side of the second sneaker, with overlapping instep portions of the first sneaker and the second sneaker attached to one another. Similarly, overlapping outer portions of the first sneaker and second sneaker are conjoined. Gaps between the upper portions of the first and second sneaker may be filled using material from the removed tongues or other material. The joined upper portions and filled gaps form an upper section of the purse. An interior cavity of the purse is lined, thereby defining a primary interior portion. An opening portion is attached to the purse upper section. The opening portion may be alternatively opened and fastened closed. A strap may be attached to the purse, for example using a shoelace attached through eyelets in the first and second sneakers.

A sneaker purse serves the utilitarian purposes of a traditional purse, and may do so without being associated with traditional femininity or fashion. Indeed, a sneaker purse may make a statement contrary to such traditional associations. A sneaker purse may appeal to athletes. Further, a sneaker purse made from high-top sneakers may appeal to individuals who see high-top sneakers as a symbol of counter-culture and rebellion, who might otherwise not wish to be associated with the attributes of either an athlete or a traditional purse carrier. A sneaker purse may be made from low cost and/or previous used components, thereby appealing to thrifty and/or ecology conscious consumers. A sneaker purse may have a high whimsical appeal that crosses gender boundaries. And not least, just as sneakers are available in a multitude of colors and styles, a sneaker purse can similarly be made in a multitude of colors and styles to appeal to a wide market.

Under a first exemplary embodiment, a sneaker purse is made from elements of two high-top sneakers. While the two high-top sneakers may be fully assembled, partially assembled, or unassembled, the description of the first embodiment assumes the purse was formed from elements of two fully assembled high-top sneakers. Similarly, while the description assumes the purse is formed from elements of a left sneaker and elements of a right sneaker, there is no objection to forming the purse from elements of, for example, two left sneakers or two right sneakers.

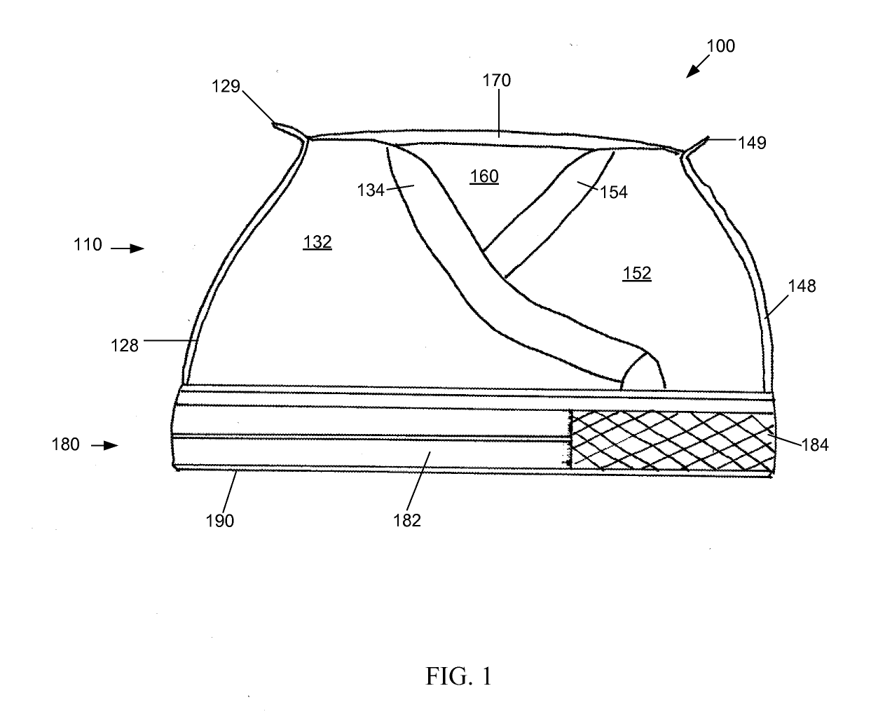

FIG. 1 is a schematic diagram of a sneaker purse 100 under the first exemplary embodiment. The sneaker purse 100 has an upper section 110 attached to a base 180. The upper section 110 is formed from a first high-top sneaker and a second high-top sneaker. The base 180 is formed from the bottom of the first high-top sneaker, and includes a sole 190, and a base side panel 182. As shown by FIG. 1, the base 180 may include a kick guard 184, where the kick guard 184 covers the front or toe portion of the base side panel 182. The kick guard 184 serves to indicate the front of the purse 100.

The upper section 110 includes a first instep side 132 from the first high-top sneaker attached to a second instep side 152 from the second high-top sneaker. The first instep side 132 is attached to a heel side strip 128, where the heel side strip 128 is formed from the heel of the first high-top sneaker. The heel side strip 128 may extend beyond the top of the first instep side 132, forming a rear tab 129. Similarly, the second instep side 152 is attached to a toe side strip 148, where the toe side strip 148 is formed from the back of the second high-top sneaker. An instep wedge 160 is attached between the first instep side 132 and the second instep side 152, located where the first instep side 132 separates from the second instep side 152. In particular, the wedge may be located between a first instep lacing region 134 and a second instep lacing region 154. The instep wedge 160 may be formed, for example, from a first tongue of the first high-top sneaker, or from the second tongue of the second high-top sneaker. However, the instep wedge 160 may alternatively be made from other discarded portions of the first sneaker and/or the second sneaker, or other fabric.

While FIG. 1 shows a portion of the second instep side 152 attached substantially inside the first instep side 132, there is no objection to attaching the first instep side 132 to the second instep side 152 such that a portion of the first instep side 132 is substantially inside the second instep side 152.

The first and second instep lacing regions 134, 154 may include a plurality of eyelets (not shown). The eyelets may be used to attach a strap (not shown) to the purse 100. The strap may be formed from, for example, but not limited to, shoelaces or sneaker laces. The strap may also attach to eyelets located on a first outer lacing region (not shown) and a second outer lacing region (not shown).

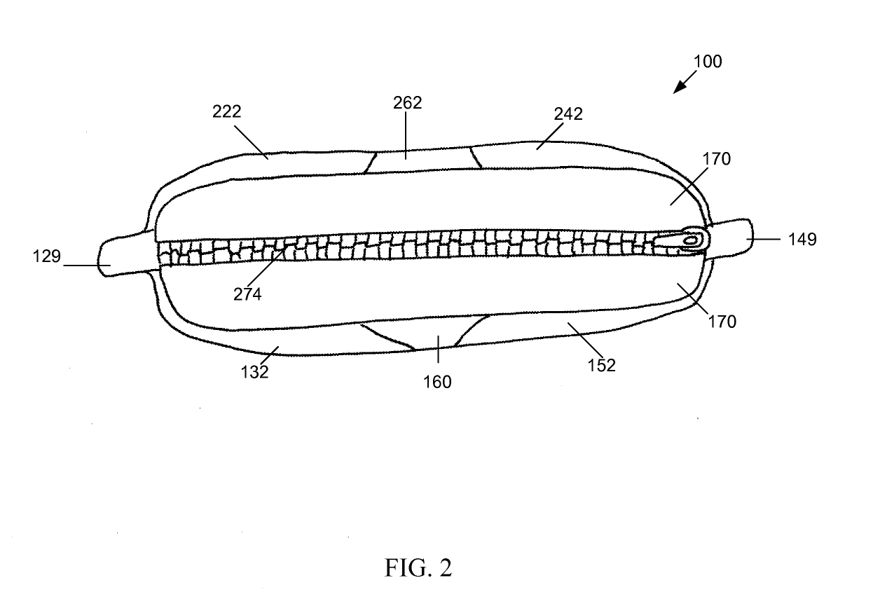

An opening portion 170 forms the top of the upper portion 110. As shown in FIG. 2, the opening portion 170 attaches to the first instep side 132, the instep wedge 160, the second instep side 152, a first outer side 222, a second outer side 242, and an outer wedge 262. The first outer side 222 is disposed substantially opposite the first instep side 132, and the second outer side 242 is disposed substantially opposite the second instep side 152.

The outer wedge 262 is substantially similar to the inner wedge 160, and is attached between the first outer side 222 and the second outer side 242, located where the first outer side 222 separates from the second outer side 242. The outer wedge 262 may likewise be formed, for example, from a first tongue of the first high-top sneaker, from the second tongue of the second high-top sneaker, or from other fabric.

The opening portion 170 provides access to a primary interior compartment (not shown), described below. The opening portion 170 may be formed of, for example, cloth, leather, suede, rubber, plastic, or other materials. Unlike the components previously listed, the opening portion 170 may not be a portion of the first high-top sneaker and the second high-top sneaker. The opening portion 170 may be fastened by a zipper 274. Alternatively, the opening portion 170 may or may not be fastened by other means familiar to persons having ordinary skill in the art, for example, but not limited to, snaps, hooks, drawstrings, hook-and-loop fasteners, such as Velcro, magnets, and other fasteners.

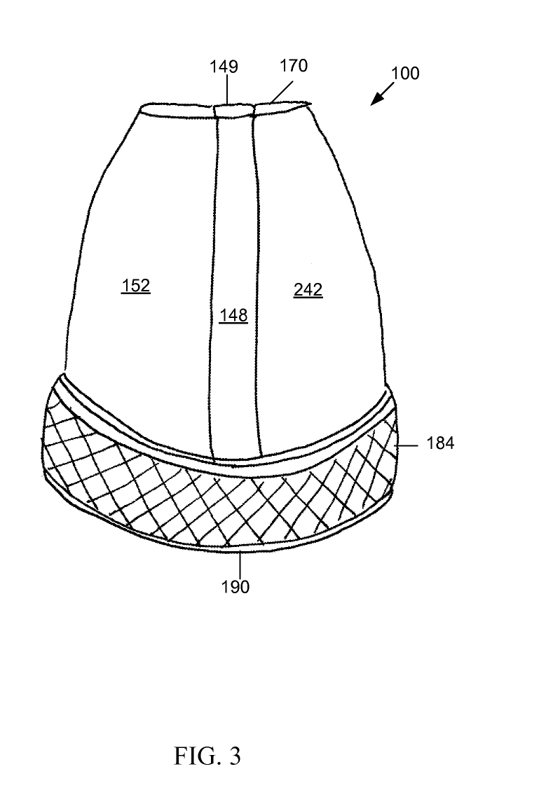

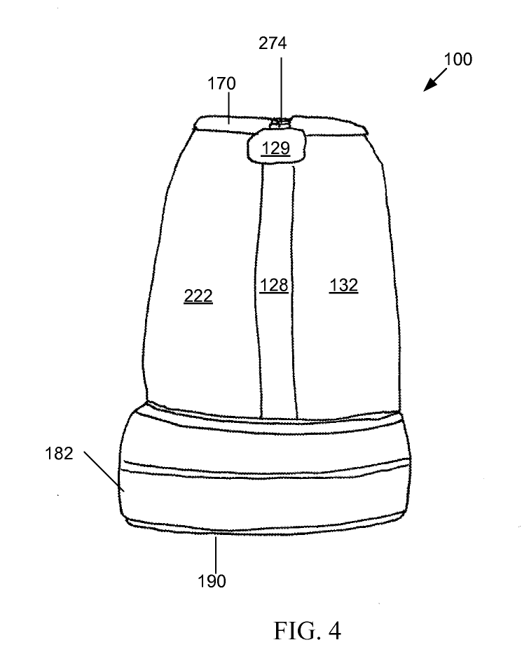

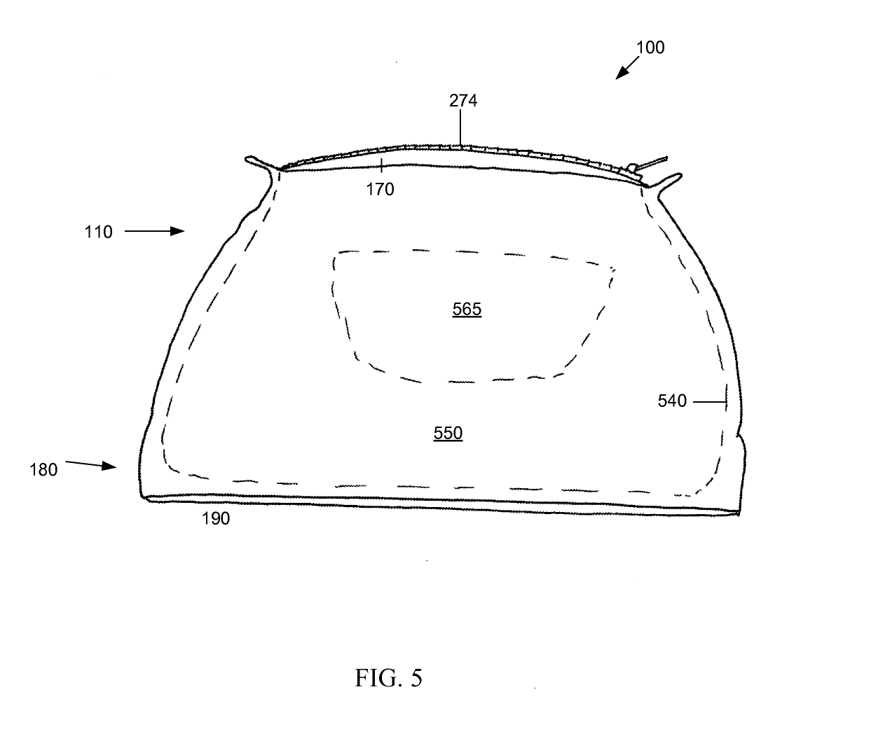

FIG. 3 shows the purse 100 from a front view, and FIG. 4 shows the purse 100 from a rear view. FIG. 5 is a cutaway view of the purse 100. The purse 100 has a primary interior compartment 550. The primary interior compartment 550 has a liner 540 separating the interior compartment 550 from the interior of the base 180 and the interior of the upper portion 110. The liner 540 may be made of cloth, for example, silk, satin, cotton, or other materials. In a preferred embodiment, the liner 540 may be made from athletic socks. The primary interior compartment 550 serves as the main storage area inside the purse 100.

The purse 100 may include one or more secondary interior compartments 565. The secondary interior compartment 565 may be formed, for example, by attaching a piece of cloth to the liner. The secondary interior compartment 565 may be attached to the liner 540 on three sides of the piece of cloth, leaving a fourth side, for example the top side, open, for example, like a pocket, or the secondary interior compartment may be fastened, as above, using, for example, a zipper, snaps, buttons, or other fastening means.

The primary interior compartment 550 may be further segmented, as is familiar to persons having ordinary skill in the art. Additional interior compartments, such as pen holders, cell phone holders, coin holders, license and credit card holders, as well as accessories such as mirrors, key clips, money clips, and other fasteners are similarly within the scope of this invention.

In one alternative embodiment, a bottom panel may be disposed between the liner 540 and the sole 190 to reinforce the base 180. The bottom panel may be, for example, an insole made from, for example, rubber, plastic, or other materials.

It should be noted that the terms “attaching” and “attached”, as used herein, may refer to sewing, gluing, heat bonding, and/or otherwise adhering the various components as known to persons having ordinary skill in the art.

In one variation of the first embodiment, the instep wedge 160 and/or the outer wedge 262 may include a pouch formed, for example, by doubling over the first high-top sneaker tongue or the second high-top sneaker tongue. The pouch may be open at the top, and may be fastened by a fastening means, for example, a zipper, hooks and loops, snaps, or other fasteners.

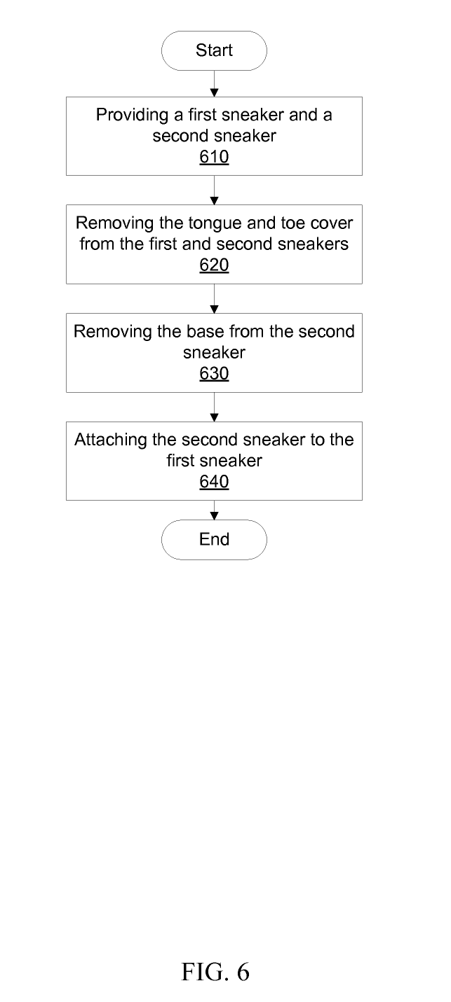

FIG. 6 is a flowchart of a second exemplary embodiment of the current invention, a method for forming a sneaker purse. It should be noted that any process descriptions or blocks in flow charts should be understood as representing modules, segments, portions of code, or steps that include one or more instructions for implementing specific logical functions in the process, and alternative implementations are included within the scope of the present invention in which functions may be executed out of order from that shown or discussed, including substantially concurrently or in reverse order, depending on the functionality involved, as would be understood by those reasonably skilled in the art of the present invention.

As shown by block 610, a first sneaker and a second sneaker are provided. The first sneaker may be a right sneaker or a left sneaker, and the second sneaker may be a right sneaker or a left sneaker. However, there is no objection to the first and/or second sneaker being having neither a left nor right orientation. For the purposes of this example, the first sneaker and the second sneaker are assumed to be a matched left and right pair.

The tongue and the toe cover are at least partially removed from the first and second sneakers, as shown by block 620. In general, the tongue and toe cover may be completely removed from the second sneaker, whereas at least a portion of the material forming the toe cover portion of the first sneaker may remain attached to the base of the first sneaker, for example, to provide an attachment location where additional elements may be attached to the base of the first sneaker.

The base is removed from the second sneaker, as shown by step 630. In general, the removed base of the second sneaker may be discarded. The second sneaker, without the removed base, may be attached to the first sneaker, as shown by block 640.

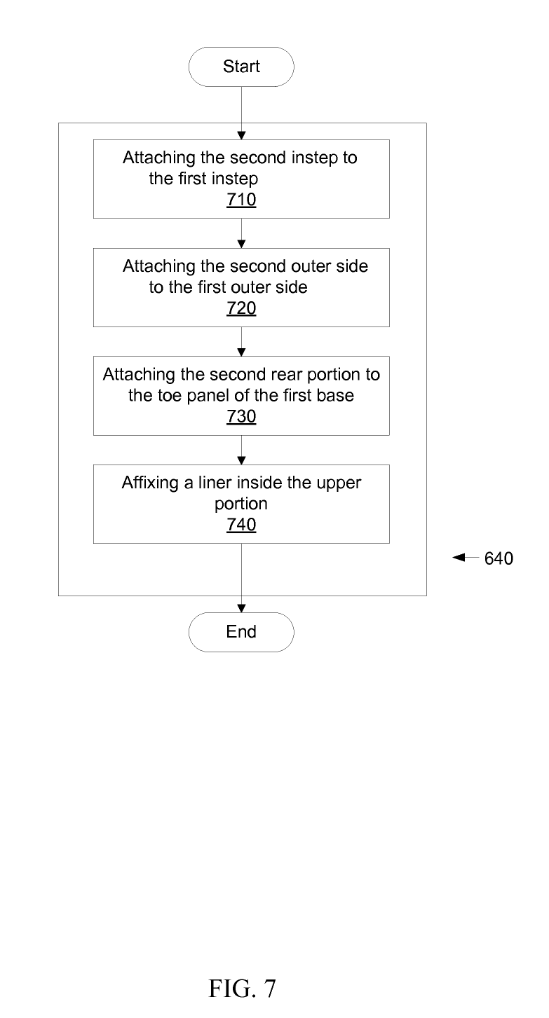

FIG. 7 is a flowchart expanding block 640. The instep of the second sneaker is attached to the instep of the first sneaker, as shown by block 710. As attached, the first sneaker and the second sneaker are generally oriented in opposing directions, and are attached as to be at least partially overlapping, so that the toe portion of the first sneaker is generally located near the heel portion of the second sneaker, and the toe portion of the second sneaker is generally located near the heel portion of the first sneaker. In general, the first instep and the second instep overlap significantly, and the first instep may be attached to either the inside or the outside of the second instep. There is no objection to trimming the interior instep so that only enough material remains to secure the first instep to the second instep.

The second outer side is attached to the first outer side, as shown by block 720. In general, the first outer side and the second outer side overlap significantly, and the first outer side may be attached to either the inside or the outside of the second outer side. There is no objection to trimming the interior outer side so that only enough material remains to secure the first outer side to the second outer side.

The rear portion of the second sneaker is attached to the toe panel of the base of the first sneaker, as shown by block 730. The rear portion may be attached to the base of the first sneaker, for example, by affixing it to a portion of the toe remaining attached to the base, as described above. Alternatively, the rear portion may be affixed directly to the base of the first sneaker, for example, using an intermediary fastening piece of fabric to provide sufficient surface area for the attachment.

A liner may be affixed inside the upper portion of the purse formed by the first sneaker as attached to the second sneaker, as shown by block 740. The liner may be made of cloth, for example, silk, satin, cotton, or other materials. As mentioned previously, in a preferred embodiment, the liner may be made from athletic socks.

While the above description has referred to sneakers and high-top sneakers, there is no objection to forming the purse from other types of footwear, for example, but not limited to, mid-top sneakers, high-top sneaker boots, and desert boots. It should be noted that while the embodiments generally describe using a first sneaker and a second sneaker to construct the sneaker purse, there is no objection to using portions of three or more sneakers to construct the sneaker purse. Similarly, there is no objection to using materials not from sneakers, such as canvas, rubber, or other materials used in forming sneakers to approximate the appearance of sneaker components in the sneaker purse.

In summary, a sneaker purse has been presented formed from a first sneaker and a second sneaker. It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A handbag having a bottom, an upper section and a primary interior compartment, comprising:
a first sneaker comprising a base attached to a first upper portion, said first upper portion further comprising a first heel disposed between a first instep side and a first outer side, said base further comprising a sole; and
a second sneaker comprising a second upper portion, said second upper portion further comprising a second heel, a second instep side and a second outer side,
wherein said handbag bottom comprises said base, and said upper section comprises said first upper portion and said second upper portion.

2. The handbag of claim 1, wherein;
said second heel is attached to said first toe;
said second instep is attached to said first instep; and
said second outer side is attached to said first outer side.

3. The handbag of claim 1, wherein;
said second heel is attached to said first toe;
said second instep is attached to said first outer side; and
said second outer side is attached to said first instep.

4. The handbag of claim 1, further comprising a side pouch formed substantially of a tongue formed of one of a group comprising a first tongue from said first sneaker, and a second tongue from said second sneaker.

5. The handbag of claim 4, wherein said side pouch is disposed in a wedge section substantially between said first sneaker and said second sneaker.

6. The handbag of claim 1, further comprising a strap.

7. The handbag of claim 6, wherein said strap attaches to said handbag through a plurality of eyelets disposed in said handbag upper section.

8. The handbag of claim 6, wherein said strap comprises a shoelace.

9. The handbag of claim 1, further comprising a secondary interior compartment disposed substantially within said primary interior compartment.

10. The handbag of claim 1, further comprising a means to fasten said primary interior compartment.

11. The handbag of claim 1, wherein said primary interior compartment further comprises a liner.

12. The handbag of claim 11, further comprising an opening portion disposed between said upper section and said liner.

13. The handbag of claim 1, wherein said first sneaker is a high top sneaker and said second sneaker is a high top sneaker.

14. The handbag of claim 1, wherein said first sneaker is a high top sneaker boot and said second sneaker is a high top sneaker boot.

15. The handbag of claim 9, further comprising a means to fasten said secondary interior compartment.

16. A method for forming a handbag from a first sneaker comprising a first base attached to a first upper portion, said first upper portion further comprising a first heel disposed between a first instep side and a first outer side, and a first toe disposed opposite said first heel and between said first instep side and said first outer side, said toe attached to a first tongue, said base further comprising a sole, and a side panel comprising an instep panel, an outer panel, a toe panel and a heel panel, and a second sneaker comprising a second upper portion, said second upper portion further comprising a second heel disposed between a second instep side and a second outer side, the method comprising the step of attaching said first sneaker to said second sneaker.

17. The method of claim 16 further comprising the step of at least partially removing said first toe and said first tongue from said first sneaker.

18. The method of claim 17, further comprising the steps of:
attaching said second instep to said first instep; and
attaching said second outer side to said first outer side,
wherein said second heel is adjacent to said first toe panel.

19. The method of claim 18, further comprising the steps of:
removing a second base from said second sneaker;
removing a second toe from said second sneaker; and
at least partially removing said second tongue from said second sneaker.

20. A method for forming a handbag, comprising the steps of:
forming an upper portion from a first sneaker instep, a second sneaker instep, a first sneaker outer side, and a second sneaker outer side;
attaching said first sneaker instep to said second instep;
attaching said first sneaker outer side to said second sneaker outer side;
forming an interior compartment within said upper portion; and
attaching said upper portion to a base, wherein said base comprises a sneaker bottom portion.
